(19) United States
(12) Patent Application Publication
(10) Pub. No.: US 2024/0347772 A1
(43) Pub. Date: Oct. 17, 2024

(54) Liquid Electrolyte Composition, and Electrochemical Cell Comprising Said Electrolyte Composition

(71) Applicant: Bayerische Motoren Werke Aktiengesellschaft, Muenchen (DE)

(72) Inventors: Alexander ADAM, Muenchen (DE); Peter LAMP, Landsberg am Lech (DE); Arianna MORETTI, Muenchen (DE); Sebastian SCHARNER, Tuerkenfeld (DE)

(21) Appl. No.: 18/580,249

(22) PCT Filed: Jul. 13, 2022
(86) PCT No.: PCT/EP2022/069660

§ 371 Date: Jan. 18, 2024

(30) Foreign Application Priority Data
Jul. 21, 2021 (DE) 10 2021 118 811.3

(51) Int. Cl. H01M 10/0568; H01M 10/0525; H01M 10/0567

(52) U.S. Cl. CPC H01M 10/0568; H01M 10/0525; H01M 10/0567

(57) ABSTRACT

A liquid electrolyte composition for an electrochemical cell is provided. The liquid electrolyte composition includes the following components: (A) sulfur dioxide; (B) at least one salt containing an anionic complex with at least one bidentate ligand. The ligand along with a central ion Z of the anionic complex forms a five to eight-membered ring containing a sequence of 2 to 5 carbon atoms, said sequence being optionally interrupted by a heteroatom.

### CROSS REFERENCE TO RELATED APPLICATION

This application contains subject matter related to U.S. application Ser. No. ______, entitled “Liquid Electrolyte Composition, and Electrochemical Cell Comprising Said Electrolyte Composition,” filed on even date herewith (Attorney Docket No. 080437.PH267US).

### BACKGROUND AND SUMMARY

The present invention relates to an electrolyte composition and to an electrochemical cell comprising the electrolyte composition.

Electrochemical cells are of major importance in many technical fields. In particular, electrochemical cells are often used for applications in which low voltages are required, such as for the operation of laptops or mobile phones. An advantage of electrochemical cells is that many individual cells can be connected together. For example, cells connected in series can deliver a high voltage, while connecting cells in parallel results in a high nominal capacity. Such interconnections result in higher-energy batteries. Such battery systems are also suitable for high-voltage applications and can, for example, allow vehicles to be driven electrically or to be used for stationary energy storage.

In the following, the term “electrochemical cell” is used synonymously for all designations customary in the art for rechargeable galvanic elements, such as cell, battery, battery cell, accumulator, battery accumulator and secondary battery.

An electrochemical cell is capable of providing electrons for an external circuit in the discharging operation. Conversely, an electrochemical cell can be charged by the supply of electrons in the charging operation by means of an external circuit.

An electrochemical cell has at least two different electrodes: a positive electrode (cathode) and a negative electrode (anode). The two electrodes are in contact with an electrolyte composition.

The most commonly used electrochemical cell is the lithium-ion cell, also called lithium-ion battery.

Lithium-ion cells known from the art have a composite anode, which very often includes a carbon-based anode active material, typically graphitic carbon, which is deposited on a metallic copper carrier foil. The cathode generally includes metallic aluminum which is coated with an active cathode material, for example a layered oxide. As a layered oxide, for example, one can use LiCoO₂ or LiNi_{1/3}Mn_{1/3}Co_{1/3}O₂, which can be coated onto a rolled aluminum carrier foil.

Electrolyte composition plays a key role in the safety and performance of an electrochemical cell. This ensures the charge balance between the cathode and anode during the charging and discharging process. The flow of current required for this is achieved by the ion transport of a conductive salt in the electrolyte composition. In lithium-ion cells, the conductive salt is a lithium conductive salt, and lithium ions serve as the current-carrying ions.

There is therefore a need to select a suitable conductive salt which can be dissolved in the electrolyte composition to a sufficient extent and which also has suitable ion conductivity in order to maintain effective charge equalization during operation. The most common conductive salt in lithium-ion cells is lithium hexafluorophosphate (LiPF₆).

In addition to the lithium conductive salt, electrolyte compositions contain a solvent which enables dissociation of the conductive salt and sufficient mobility of the lithium ions. Liquid organic solvents are known in the art that consist of a variety of linear and cyclic dialkyl carbonates. Mixtures of ethylene carbonate (EC), dimethyl carbonate (DMC), diethyl carbonate (DEC), propylene carbonate (PC), and ethyl methyl carbonate (EMC) are generally used.

It is important to note that each solvent has a specific stability range for the cell voltage, also referred to as the “voltage window.” In this voltage window, the electrochemical cell can run stably during operation. If the cell voltage approaches the upper voltage limit, an electrochemical oxidation of the components of the electrolyte composition takes place. At the lower end of the voltage window, on the other hand, reductive processes take place. Both redox reactions are unwanted, reduce the performance and reliability of the cell, and in the worst case, lead to its failure.

The processes described herein are particularly relevant for the deep discharging and overcharging of a lithium-ion cell.

Lithium-ion cells with the organic electrolyte compositions of the art tend to gas during the charging and discharging processes. “Gassing” is understood to means an electrochemical decomposition of the components of the electrolyte into volatile and gaseous compounds due to the use of too high a cell voltage. Gassing reduces the proportion of the electrolyte and leads to the formation of unwanted decomposition products, resulting in a shorter service life and lower performance of the lithium-ion cell.

In order for the cell to be able to work in the broadest possible potential range, fluorinated solvents or additives are added to the electrolyte compositions of the art. Fluorinated solvents such as fluoroethylene carbonate (FEC) are chemically inert and electrochemically stable with respect to the operating voltages of the lithium-ion cell.

A common drawback of fluorinated electrolytes is that in the event of a thermal defect in the cell, increased heat release and the formation and emission of harmful gases such as hydrogen fluoride (HF) can occur.

Because of these drawbacks, lithium-ion cells have a large number of regulating and control mechanisms in order to keep the cells in a voltage range that is optimal for the respective solvent during operation and thus stabilize the electrolyte composition.

Various approaches for stable electrolyte compositions are known in the art.

EP 1689756 B1 describes a process for preparing weakly coordinating anions of the formula X(OR^{F})ₘ, in which X is selected from the group consisting of B, Al, Ga, In, P, As and Sb, m is 3 or 5, and R^{F} represents a straight-chain or branched-chain, partially or fully fluorinated alkyl or aryl radical. The weakly coordinating anions form salts with mono- or divalent cations, preferably with alkali metal ions. Because of the chemical stability, in particular of the anion, the salts disclosed were proposed inter alia for use as inert lithium conductive salts in lithium-ion batteries. However, an electrolyte composition with the weakly coordinating anions for use in lithium-ion batteries has not been disclosed.

In addition to selecting a chemically inert conductive salt, the stability of the battery cells can also be increased by selecting a suitable solvent. Sulfur dioxide (SO₂) was already discussed as an inorganic solvent in electrolyte compositions in David Linden's “Handbook of Batteries” (2nd edition, McGraw Hill, 1994). Electrolyte compositions based on sulfur dioxide have, in particular, increased ionic conductivity and thus allow battery cells to be operated at high discharge currents without adversely affecting the stability of the cells. Furthermore, electrolyte compositions based on sulfur dioxide are characterized by a high energy density, a low self-discharge rate, and limited overcharging and deep discharging.

A drawback of sulfur dioxide is that it only insufficiently dissolves many lithium conductive salts, which are readily soluble in organic solvents. Therefore, for example, the widely used lithium conductive salt lithium hexafluorophosphate cannot be used for electrolyte compositions containing sulfur dioxide.

EP 1201004 B1 discloses a rechargeable electrochemical cell with an electrolyte based on sulfur dioxide. In this case, sulfur dioxide is not added as an additive, but represents the main component of the electrolyte composition. It should therefore at least partially ensure the mobility of the ions of the conductive salt, which bring about the charge transport between the electrodes. In the cells described herein, lithium tetrachloroaluminate is used as a lithium-containing conductive salt in combination with a cathode active material made of a metal oxide, in particular an intercalation compound such as lithium cobalt oxide (LiCoO₂). Functional and rechargeable cells have been obtained by adding a salt additive, for example an alkali metal halide such as lithium fluoride, sodium chloride or lithium chloride, to the electrolyte composition containing sulfur dioxide.

EP 2534719 B1 presents a rechargeable lithium battery cell with an electrolyte based on sulfur dioxide in combination with lithium iron phosphate as a cathode active material. Lithium tetrachloroaluminate was used as the preferred conductive salt in the electrolyte composition. In experiments with cells based on these components, a high electrochemical resistance of the cells could be demonstrated.

WO 2021/019042 A1 describes rechargeable battery cells with an active metal, a layered oxide as a cathode active material and an electrolyte containing sulfur dioxide. Due to the poor solubility of many common lithium conductive salts in sulfur dioxide, a conductive salt of the formula M⁺[Z(OR)₄]⁻ was used in the cells, where M represents a metal selected from the group composed of alkali metal, alkaline earth metal and a metal of group 12 in the periodic table, and R is a hydrocarbon radical. The alkoxy groups-OR are each monovalently bonded to the central atom Z, which can be aluminum or boron. In a preferred embodiment, the cells contain a perfluorinated conductive salt of the formula Li⁺[Al(OC(CF₃)₃)₄]⁻. Cells consisting of the described components show a stable electrochemical performance in experimental studies. In addition, the conductive salts, in particular the perfluorinated anion, have surprising hydrolytic stability. Furthermore, the electrolytes should be oxidation-stable up to an upper potential of 5.0 V. It was further shown that cells with the disclosed electrolytes can be discharged or charged at low temperatures of down to −41° C. However, no measurements of electrochemical performance at high temperatures have been carried out.

The thermal stability of perfluorinated lithium aluminates at high temperatures was examined in a scientific study by Malinowski et al. (Dalton Trans., 2020, 49, 7766). In the study, the authors characterized various properties of [Al(OC(CF₃)₃)₄] salts, including the temperature stability of the lithium derivative. Thermogravimetric studies showed that the compound Li[Al(OC(CF₃)₃)₄] already shows a mass loss at 105° C., which is caused by an incipient decomposition of the fluorinated anion.

The object of the invention is to provide an electrolyte composition for an electrochemical cell, and in particular for rechargeable batteries, that is inexpensive and safe to operate at various working voltages.

The invention achieves this object by means of a liquid electrolyte composition for an electrochemical cell in accordance with embodiments of the independent claim(s).

Advantageous embodiments of the electrolyte composition according to the invention are described in the dependent claims, which can optionally be combined with one another.

### DETAILED DESCRIPTION

According to the invention, the object is achieved by a liquid electrolyte composition for an electrochemical cell. The electrolyte composition includes the following components: (A) sulfur dioxide; (B) at least one salt, wherein the salt includes an anionic complex with at least one bidentate ligand and the salt corresponds to Formula (1) below,

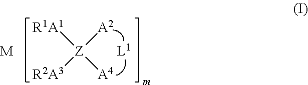

### Formula (II)

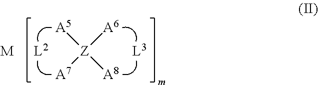

or Formula (III)

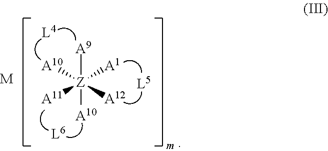

M is a metal cation selected from the group composed of the alkali metals, alkaline earth metals and metals of group 12 in the periodic table, m represents an integer from 1 to 2, and Z denotes a central ion selected from the group composed of the elements of group 2 to 16 of the periodic table, including the group of the lanthanides. A1 to A12 each represent a coordination element that bonds to the central ion Z, wherein A1 to A12 are each independently selected from the group composed of elements of group 15 and 16 of the periodic table. R1 and R2 respectively denote a monovalent and a terminal radical and are independently selected from the groups consisting optionally of a fluorine-substituted hydrocarbon radical, triflyl radical, triflate radical and fluorosulfonate radical. L1 to L6 each independently represent an aliphatic or aromatic bridging group. The bridging group forms a five to eight-membered ring with the central ion Z and with two coordination elements bonded to the bridging group, wherein the ring includes a sequence of 2 to 5 carbon atoms, optionally interrupted by a heteroatom.

The salts according to the invention have an ion that includes at least one bidentate ligand. In the context of the invention, a bidentate ligand is understood to refer to a molecule that includes at least two coordination elements and bonds to a central ion Z via the at least two coordination elements. It would also be conceivable to use other multidentate ligands having a different denticity, such as for example tridentate, tetradentate, pentadentate or hexadentate.

Bidentate or multidentate ligands are also generally known as chelate ligands, and the complexes composed of them as chelate complexes. The anion of the salt of Formula (I), formula (II) and formula (III) is thus a chelate complex. In the context of this invention, chelate complexes and the salts formed therefrom have various advantages over monovalent complexes and the salts formed therefrom.

Chelate complexes are chemically more stable than their monovalent derivatives. The bonds between the chelate ligand and the central ion are difficult to break, which is why the chelate complexes according to the invention are chemically inert to external chemical and physical influences.

According to the invention, a chelate complex represents the anion of the at least one salt of Formulas (I), (II) or (III), the salt serving as the conductive salt of the electrolyte composition. The electrolyte composition thus enables charge balancing between the two electrodes with which it is in contact.

Another advantage is the high affinity of the chelating ligand for the central ion. The chelate complexes used according to the invention are chemically and electrochemically stable compounds which, due to the strongly coordinating properties of the ligand with respect to the central ion, have a low affinity for binding to positively charged ions. The chelate complexes themselves are therefore weakly coordinating anions. Therefore, the conductive salt in the electrolyte composition can dissociate almost completely without reforming back to the starting salt and forms ions with a high mobility and a correspondingly high ionic conductivity in solution. This in turn increases the electrochemical performance of the electrochemical cell.

Because of these properties, the chelate complexes used according to the invention, in particular the salts composed thereof, are resistant to both temperature and hydrolysis.

According to the present invention, the salts described are sufficiently soluble in liquid sulfur dioxide, which is the inorganic solvent of the electrolyte composition. In the context of the invention, sulfur dioxide is not only contained as an additive in low concentrations in the electrolyte composition, but is also present to an extent that it can ensure the mobility of the ions of the conductive salt as a solvent.

Sulfur dioxide is gaseous at room temperature under atmospheric pressure and forms stable liquid solvate complexes with lithium conductive salts, which have a noticeably reduced vapor pressure compared to sulfur dioxide as a pure substance. The gaseous sulfur dioxide is thus bound in liquid form and can be handled safely and comparatively easily. A particular advantage is the non-combustibility of sulfur dioxide itself and of the solvate complexes, which increases the operational safety of the electrolyte compositions based on such solvate complexes and of the cells produced using the electrolyte composition.

The salts described with the chelate complexes of Formulas (I), (II) and (III) are non-flammable. The electrolyte compositions according to the invention are therefore also non-flammable and enable safe operation of an electrochemical cell which includes the disclosed components of the electrolyte composition. If sulfur dioxide escapes from the cell due to mechanical damage, it cannot ignite outside the cell.

In addition, the electrolyte composition according to the invention is also inexpensive compared to conventional organic electrolytes. The elevated temperature stability and resistance to hydrolysis enable direct and almost complete recycling of the electrolyte composition from old batteries without increased effort. Hydrothermal processes under high pressure and at high temperatures are usually used to recycle old batteries. Conventional electrolyte compositions are usually not resistant to hydrolysis and therefore have to be processed in some other way. For this purpose, the electrolyte compositions are extracted from batteries in a laborious process, for example by rinsing the cells with supercritical carbon dioxide. In contrast, more recent electrolyte formulations based on aluminate, borate or gallate salts, as described in the art, are usually not sufficiently thermally stable.

The electrolyte composition described herein is thermally stable and resistant to hydrolysis and can therefore be recycled directly from the electrochemical cells at low cost using water-based extraction methods. Because of the water solubility of the components, the electrolyte composition described herein has a high recycling potential with a high recycling rate.

Recycling reduces both the primary raw material consumption and the energy demand of the electrolyte composition required for the production of a freshly manufactured electrolyte composition, and thus also the carbon dioxide emission caused during this manufacturing process. Thus, the manufacturing costs of the electrolyte composition according to the invention and the electrochemical cell manufactured using the electrolyte composition can be kept low.

According to the invention, the electrolyte composition includes at least one salt of Formulas (I), (II) or (III), wherein the salt contains an anionic complex with at least one bidentate ligand.

In the formula, the charge of the anion is stoichiometrically balanced by a positively charged metal cation M selected from the group composed of the alkali metals, alkaline earth metals and metals of group 12 in the periodic table. Preferably, the metal cation is a lithium ion and the salt is a lithium salt. Accordingly, m is an integer from 1 to 2, where m is stoichiometrically determined by the oxidation number of the metal cation used.

Z in the formula (I), (II) or (III) is a central ion which is selected from the group composed of the elements of groups 2 to 16 and the group of lanthanides of the periodic table. The central ion Z is preferably selected from the group consisting of the elements B, Al, Ga, In, P, Ti, Nb, Zn, V and La. Z is particularly preferably selected from the group composed of aluminum, boron and phosphorus.

If the central ion corresponds to one of the elements aluminum, boron or phosphorus, the respective salts formed therefrom are either aluminates, borates or phosphates. Accordingly, the anion of the salt of Formulas (I), (II) or (III) has a single negative charge.

The coordination elements A1 to A12 each bond to the central ion Z and to the bridging group, the coordination elements A1 to A12 each being independently selected from the group composed of elements from groups 15 and 16 of the periodic table.

If the coordination element is an element selected from the group composed of the elements of group 15 of the periodic table, then the coordination element in question is provided with a fluorine-containing radical. In other words, the coordination element in question thus has a total of three bonds, a bond to the central ion Z, a bond to the bridging group and a bond to the fluorine-containing radical.

The fluorine-containing radical is in particular selected from the group composed of a triflyl radical, triflate radical, tosyl radical, fluorosulfonate radical and perfluorinated C₁-C₈ alkyl radical.

In a preferred embodiment of the invention, the at least one coordination element includes oxygen. All of the coordination elements are particularly preferably oxygen.

In a further aspect, the salt is of Formula (I), wherein R₁ and R₂ each independently include an optional fluorine-substituted hydrocarbon group. The hydrocarbon radicals R₁ and R₂ are each monovalent and independently selected from the group composed of C₁-C₈ alkyl, C₂-C₁₀ alkenyl, C₂-C₁₀ alkinyl, C₆-C₁₂ cycloalkyl and C₆-C₁₂ aryl.

In the context of the invention, monovalent means that the hydrocarbon radicals R₁ and R₂ each bond to the central ion Z via a single coordination element.

In the context of the invention, the term C₁-C₈ alkyl encompasses linear or branched saturated hydrocarbon radicals having one to eight carbon atoms. Preferred hydrocarbon radicals include, for example, methyl, ethyl, n-propyl, isopropyl, n-butyl, sec-butyl, iso-butyl, tert-butyl, n-pentyl, isopentyl, 2,2-dimethylpropyl, n-hexyl, iso-hexyl, 2-ethylhexyl, n-heptyl, iso-heptyl, n-octyl and iso-octyl.

In the context of the invention, the term C₂-C₁₀ alkenyl encompasses linear or branched, at least partially unsaturated hydrocarbon radicals having two to ten carbon atoms, the hydrocarbon radicals having at least one C—C double bond. Preferred hydrocarbon radicals include, for example, ethenyl, 1-propenyl, 2-propenyl, 1-n-butenyl, 2-n-butenyl, isobutenyl, 1-pentenyl, 1-hexenyl, 1-heptenyl, 1-octenyl, 1-nonenyl and 1-decenyl.

In the context of the invention, the term C₂-C₁₀ alkinyl encompasses linear or branched, at least partially linear, unsaturated hydrocarbon radicals having two to ten carbon atoms, the hydrocarbon radicals having at least one C—C triple bond. Preferred hydrocarbon radicals include, for example, ethinyl, 1-propinyl, 2-propinyl, 1-n-butinyl, 2-n-butinyl, isobutinyl, 1-pentinyl, 1-hexinyl, 1-heptinyl, 1-octinyl, and 1-noninyl 1-decinyl.

In the context of the invention, the term C₆-C₁₂ cycloalkyl encompasses cyclic, saturated hydrocarbon radicals having six to twelve carbon atoms. Preferred hydrocarbon radicals include, for example, cyclopropyl, cyclobutyl, cyclopentyl, cyclohexyl, cycloheptyl, cyclohexyl, cyclononyl and cyclodecanyl.

In the context of the invention, the term C₆-C₁₄ aryl encompasses aromatic hydrocarbon radicals having six to twelve carbon atoms. Preferred hydrocarbon radicals include, for example, phenyl, naphthyl and anthracyl.

In a preferred embodiment, the hydrocarbon radicals R₁ and/or R₂ are at least partially fluorine-substituted.

In a particularly preferred embodiment, the hydrocarbon radicals R₁ and/or R₂ are fully fluorinated.

The bidentate chelate ligand has at least two coordination elements and a bridging group L¹ to L⁶ that binds to both coordination elements.

L¹ to L⁶ each independently represent an aliphatic or aromatic bridging group.

The bridging group forms a five to eight-membered ring with the central ion Z and with two coordination elements bonded to the central ion Z and the bridging group.

The ring includes a sequence of 2 to 5 carbon atoms, optionally interrupted by a heteroatom.

According to another aspect of the invention, the ring includes a continuous sequence of 2 to 5 carbon atoms, preferably 2 to 3 carbon atoms.

Another aspect provides that the ring has a heteroatom-interrupted sequence of 2 to 5 carbon atoms. In this case, a heteroatom is enclosed in the bridging group.

The heteroatom can be selected from the group composed of elements of main groups 15 and 16 of the periodic table.

The heteroatom can in particular be oxygen. In other words, the ring or the bridging group has in particular at least one ether group.

Advantageously, the ring has an oxygen-interrupted sequence of 2 to 4 carbon atoms.

The addition of an ether group can advantageously reduce the fluorine content of the ring. This also reduces the fluorine content of the ligand overall. Although fluorinated compounds have a good electrochemical resistance, the synthesis of such compounds is complicated and expensive. In this case, the inventors have recognized that the fluorine content in the ring and thus also in the ligand can be reduced without impairing the electrochemical stability of the ligand by adding heteroatoms to the ring.

Particularly suitable for this purpose are ether groups, which are also stable to oxidation potentials, so that the ligand is electrochemically stable despite the reduced fluorine content.

The ring may include at least one carbonyl group selected from the group composed of an imide group, carboxylic acid ester group, carboxylate group, ketone group, carboxylic anhydride group, carbonic acid ester group and carbamate ester group.

The presence of at least one carbonyl group advantageously leads to a reduced fluorine content in the ring. In this way, the proportion of fluorine in the ligand can also be reduced overall. In addition, the carbonyl groups mentioned above also have high electrochemical stability.

In an improvement of the invention, the bridging groups L¹ to L⁶ each have a linear, branched or cyclic, saturated, optionally fluorine-substituted hydrocarbon skeleton.

The hydrocarbon skeleton of the bridging groups L¹ to L⁶ preferably has 3 to 16 carbon atoms, preferably 6 to 9 carbon atoms. Hydrocarbon skeletons having a number of carbon atoms in the range mentioned yield anions which form particularly stable salts of Formula (I), Formula (II) or Formula (III).

In a preferred embodiment, the bridging groups L¹ to L⁶ each comprise an at least partially fluorine-substituted hydrocarbon skeleton.

In a particularly preferred embodiment, the hydrocarbon backbone is fully fluorinated. The previous embodiments therefore preferably comprise no hydrogen atoms.

The hydrocarbon skeleton of the bridging groups L¹ to L⁶ can comprise at least one carbonyl group selected from the group composed of an imide group, carboxylic acid ester group, carboxylate group, ketone group, carboxylic anhydride group, carbonic acid ester group and carbamate ester group.

Furthermore, the hydrocarbon skeleton of the bridging groups L¹ to L⁶ can comprise at least one heteroatom selected from the group composed of elements from main groups 15 and 16 of the periodic table.

The heteroatom can in particular comprise oxygen, which is integrated in the form of an ether functional group in the hydrocarbon skeleton of the bridging groups L¹ to L⁶.

The oxygen can also be present as an epoxide bridge in the hydrocarbon backbone of the bridging groups L¹ to L⁶. In this case, the oxygen is bound in the form of a ring in the hydrocarbon structure of the bridging groups L¹ to L⁶.

According to a further aspect, component (B) of the electrolyte composition includes at least one lithium salt of Formula (II) containing at least one ether functional group in the ring and/or an epoxide bridge in the hydrocarbon backbone. Such a lithium salt is preferably selected from the group composed of

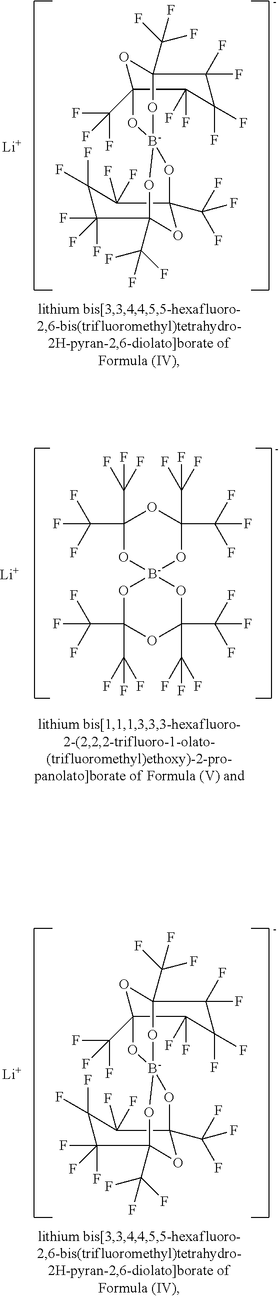

as well as combinations thereof.

According to another aspect, component (B) of the electrolyte composition includes at least one lithium salt of Formula (II) having at least one carbonyl functional group. Such a lithium salt is preferably selected from the group composed of

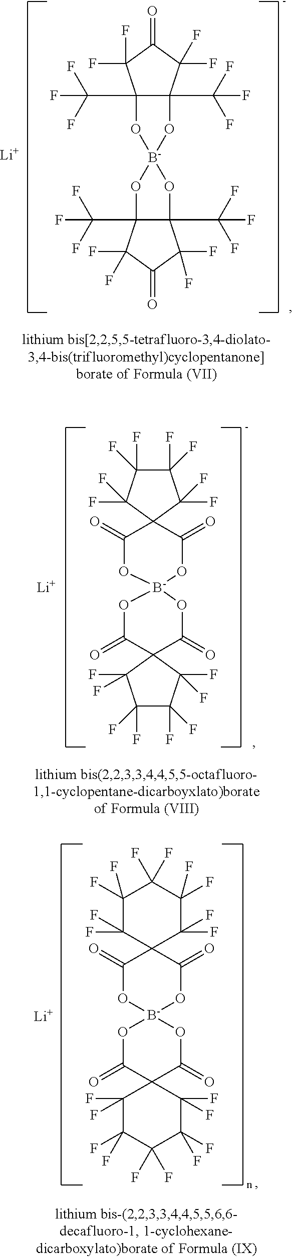

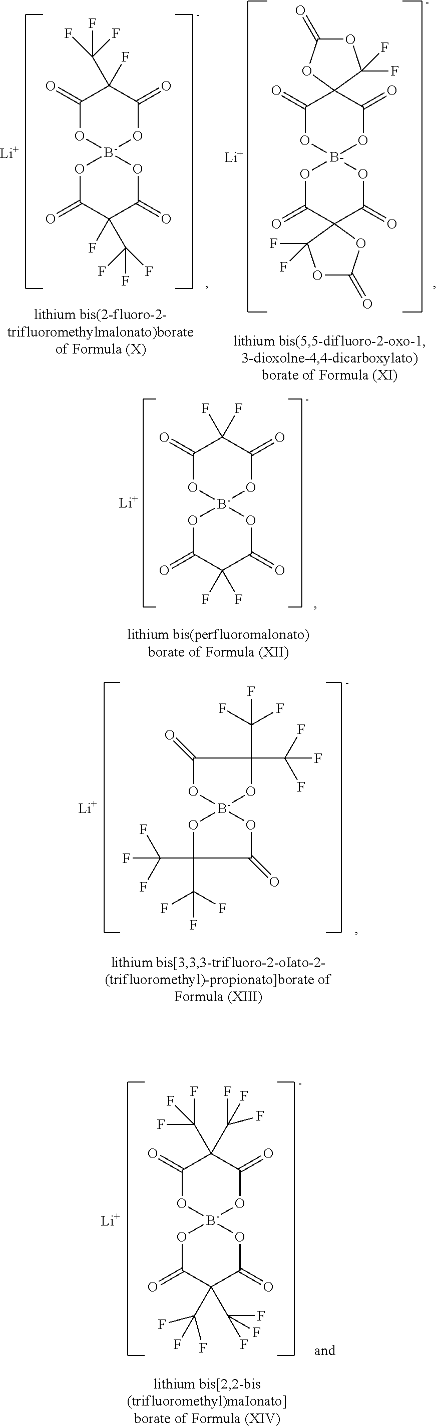

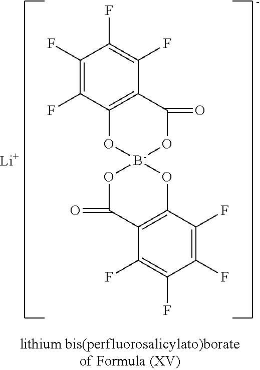

as well as combinations thereof.

The carbonyl functional group can be present in the ring and/or the hydrocarbon skeleton of the bridge radical.

According to a further aspect of the invention, component (B) of the electrolyte composition includes at least one lithium salt of Formula (II), the lithium salt containing both an ether functionality and a carbonyl group. Such a lithium salt is preferably selected from the group composed of

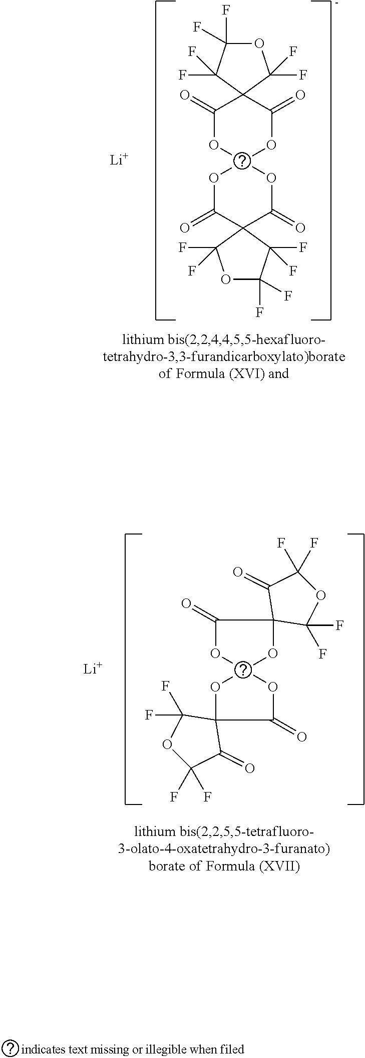

as well as combinations thereof.

In an embodiment of the invention, component (B) of the electrolyte composition includes at least one lithium salt of Formulas (II) or (III), wherein the lithium salt includes an optional fluorine-substituted aromatic bridging group and the lithium salt is preferably selected from the group composed of

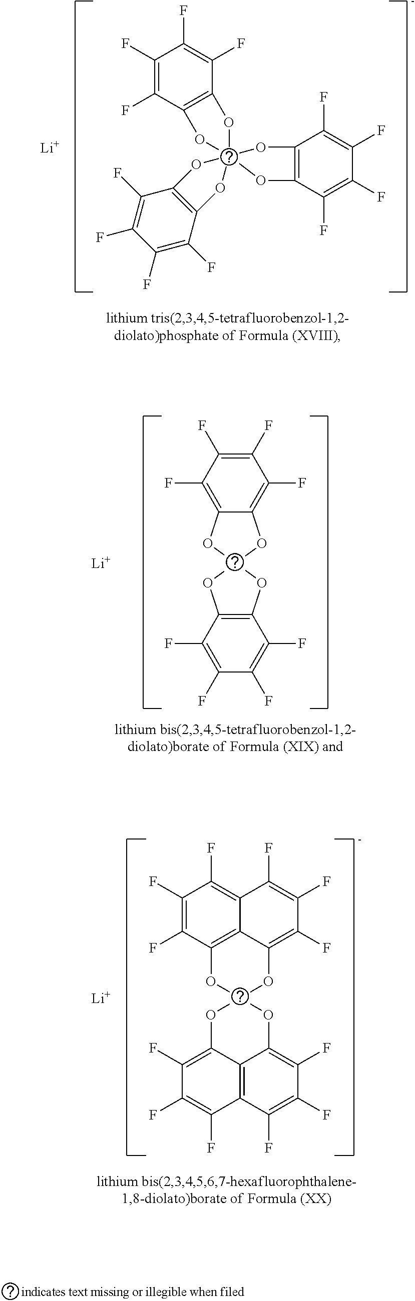

as well as combinations thereof.

In principle, the salts of Formulas (IV)-(XX) described herein fall under General Formulas (II) or (III). However, it is also conceivable that in the salts of Formulas (IV)-(XX), a chelating ligand is replaced by two ligands R₁A₁, R₂A₃ according to Formula (I). In the case of the salt of Formula (XVIII), two chelating ligands can also be substituted.

In an embodiment of the invention, the salt of component (B) is a salt of the following Formula (XXI)

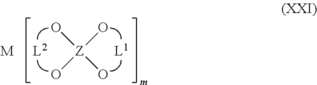

### or Formula (XXII)

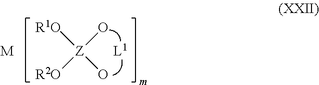

wherein Z represents a central ion selected from the group composed of aluminum and boron. In the salts of Formulas (XXI) and (XXII), the coordination elements include oxygen. Basically, Formula (XXI) is just a more specific variant of Formula (II), and Formula (XXII) is a variant of Formula (I).

The bonding of the bridging groups via the oxygen atoms to the central ion in the salts of Formulas (XXI) and (XXII) can be interpreted as a coordinate bond for the purposes of the invention. The bonding of the ligand to the central ion forms a ring consisting of a bridging group, the two oxygen atoms bonded to the bridging group and the central ion Z. The ring has at least one continuous sequence of 2 to 5 carbon atoms, preferably 2, 3 or 5 carbon atoms.

In an embodiment of the invention, such rings form salts of Formula (XXIII)

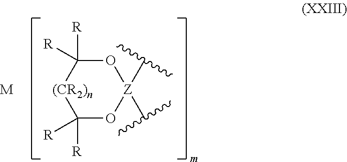

wherein n=0, 1, 2 or 3 and R represents a radical. M is a metal cation selected from the group composed of the alkali metals, alkaline earth metals and metals of group 12 of the periodic table, m is 1 or 2 and Z represents a central ion selected from the group composed of aluminum and boron. The anion of the salt of Formula (XXIII) has either two polycyclic rings according to the bonding situation of Formula (XXI) or one polycyclic ring and the radicals OR₁ and OR₂ according to the bonding situation of Formula (XXII).

The radicals R can be identical or different and independently selected from the group composed of C₁-C₄ alkyl, hydrogen and fluorine.

In the context of the invention, the term C₁-C₄ alkyl includes linear or branched saturated hydrocarbon radicals having one to four carbon atoms. Preferred hydrocarbon radicals include, for example, methyl, ethyl, n-propyl, isopropyl, n-butyl, sec-butyl, iso-butyl and tert-butyl.

In a further embodiment, the hydrocarbon radicals R can be at least partially fluorinated. Preferred fluorinated hydrocarbon radicals include, for example, trifluoromethyl or pentafluoroethyl.

When n in Formula (XXIII) is 0, the ring formed with the central ion Z, the bridging group and the two oxygen atoms bonded to the bridging group is pentacyclic and has a continuous sequence of 2 carbon atoms.

When n in Formula (XXIII) is 1, the ring formed with the central ion Z, the bridging group and the two oxygen atoms bonded to the bridging group is hexacyclic and has a continuous sequence of 3 carbon atoms.

When n in Formula (XXIII) is 3, the ring formed with the central ion Z, the bridging group and the two oxygen atoms bonded to the bridging group is eight-membered and has a continuous sequence of 5 carbon atoms.

In an embodiment, in Formula (XXIII), n is 0 and the R groups are the same and optionally correspond to fluorine-substituted methyl groups. Such chelate ligands are derived from pinacol as the simplest representative.

In an advantageous improvement of the invention, component (B) of the electrolyte composition includes at least one lithium salt of Formula (XXI). Lithium salts are particularly suitable for use as lithium conductive salts in lithium-ion batteries.

The lithium salt can preferably be selected from the group composed of lithium bis-(1,1,1,4,4,4-hexafluoro-2,3-bis-(trifluoromethyl)-2,3-butandiolate)-borate with the molecular formula Li[B(O₂C₂(CF₃)₄)₂], abbreviated here as lithium bis(perfluorpinacolato)borate (LiBPFPB), Formula (XXIV),

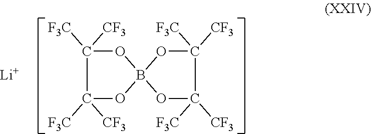

lithium bis-(1,1,1,3,3,5,5,5-octafluoro-2,4-bis-trifluoromethylpentane-2,4-diolate)aluminate having the molecular formula Li[Al(O₂C₂(CF₃)₄CF₂)₂], abbreviated here as LiOTA of Formula (XXV)

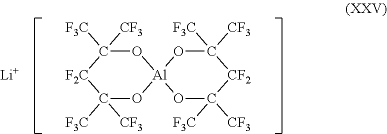

and lithium bis-(1,1,1,5,5,5-hexafluoro-2,3,3,4-tetrakis-trifluoromethylpentane-2,4-diolate)aluminate having the molecular formula Li[Al(O2C3(CF3)6)2], abbreviated here as LiHTTDA of Formula (XXVI)

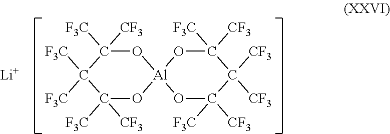

as well as combinations thereof.

The lithium salts LiBPFPB (XXIV), LiOTA (XXV), and LiHTTDA (XXVI) can be prepared according to Examples 1, 2 and 3 described below.

The lithium salts (IV)-(XX), (XXIV)-(XXVI) described herein dissolve well in liquid sulfur dioxide as a solvent. The electrolyte compositions produced therefrom are non-flammable and have extremely good ionic conductivity over a wide temperature range.

The conductivity of the lithium salts can be determined by conductive measurement methods. For this purpose, different concentrations of the lithium salts (IV)-(XX), (XXIV)-(XXVI) are prepared in sulfur dioxide. The conductivities of the solutions are then determined using a two-electrode sensor immersed in the solution at constant room temperature. For this purpose, the conductivity of the solution with the lithium salts (IV)-(XX), (XXIV)-(XXVI) is measured in a range of 0-100 mS/cm.

Due to the high electrochemical stability of the lithium salts, they do not participate in cyclic and calendric aging processes in the battery cell.

Furthermore, the lithium salts described herein have an increased thermal, chemical and electrochemical stability and a particularly pronounced resistance to hydrolysis. Thermal stability can be examined, for example, by means of thermogravimetric analysis (TGA) and differential scanning calorimetry (DSC).

Due to the increased thermal, chemical and electrochemical stability of the conductive salts described herein, the service life of lithium-ion batteries is increased. The electrolyte compositions made from the lithium salts are also less expensive to operate.

In addition, the properties of the lithium conductive salts mentioned enable the selection of a suitable recycling process. A recycling process based on water as a solvent can preferably be used. The lithium conductive salts can thus be completely recovered from the used batteries.

The improved recyclability of the electrolyte saves costs in the battery manufacturing process, which can be offset against the manufacturing costs of the electrolyte salts.

In another embodiment, the electrolyte composition includes component (B) in a concentration of 0.01 to 15 mol/L, preferably 0.1 to 10 mol/L, particularly preferably 0.5 to 5 mol/L, based on the total volume of the electrolyte composition.

The electrolyte composition may further comprise at least one other additive in a proportion of 0-10 wt. %, preferably 0.1-2 wt. %, based on the total weight of the electrolyte composition.

In an embodiment, the other additives include compounds selected from the group composed of 2-vinylpyridine, 4-vinylpyridine, cyclic exomethylene carbonates, sulfones, cyclic and acyclic sulfonates, acyclic sulfites, cyclic and acyclic sulfinates, organic esters of inorganic acids, acyclic and cyclic alkanes, aromatic compounds, halogenated cyclic and acyclic sulfonylimides, halogenated cyclic and acyclic phosphate esters, halogenated cyclic and acyclic phosphines, halogenated cyclic and acyclic phosphites, halogenated cyclic and acyclic phosphazenes, halogenated cyclic and acyclic silylamines, halogenated cyclic and acyclic halogenated esters, halogenated cyclic and acyclic amides, halogenated cyclic and acyclic anhydrides, and halogenated organic heterocycles.

The other additives contribute to the stability of the electrolyte composition during operation in an electrochemical cell.

The further additives can also make at least one further lithium-comprising conductive salt available to the electrolyte composition. In an embodiment, the further lithium-comprising conductive salt can contribute to adapting the conductivity of the electrolyte composition to the requirements of the respective cell or to increasing the corrosion resistance of the cathodic metal carrier foil.

Preferred lithium-comprising conductive salts include lithium tetrafluoroborate (LiBF₄), lithium trifluoromethanesulfonate, lithium fluoride, lithium bromide, lithium sulfate, lithium oxalate, lithium (bisoxalato)borate, lithium difluoro (oxalato)borate, lithium tetrahaloaluminate, lithium hexafluorophosphate, lithium bis(trifluoromethanesulfonyl)imide (LiTFSI), and lithium bis(fluorosulfonyl)imide (LiFSI).

Likewise, the other additives can also include other solvents. Other solvents can contribute to adjusting the solubility of the electrolyte composition with respect to polar or non-polar components therein.

The other solvents preferably include vinyl ethylene carbonate (VEC), ethyl methyl carbonate (EMC), vinylene carbonate (VC) and 4-fluoro-1,3-dioxolan-2-one (FEC).

In another embodiment, the further additives can also include at least one solid inorganic lithium ion conductor (solid electrolyte). Suitable examples of solid inorganic lithium ion conductors include perovskites, garnets, sulfides, and amorphous compounds such as glasses, and combinations thereof.

In a particularly preferred embodiment, the electrolyte composition includes the following components: (A) sulfur dioxide; (B) at least one salt of Formula (I), Formula (II) or Formula (III) above in a concentration of 0.01-15 mol/L, preferably 0.1-10 mol/L, based on the total volume of the electrolyte composition, the salt preferably being a lithium salt, particularly preferably selected from the group composed of the compounds of Formulas (IV)-(XX) and Formulas (XXIV)-(XXVI) and combinations thereof; (C) 0-10 wt. %, preferably 0.1-2 wt. %, of at least one additive, the additive preferably being selected from the group composed of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI) and bis(fluorosulfonyl)imide (LiFSI), and combinations thereof, based on the total weight of the electrolyte composition.

Furthermore, the invention relates to an electrochemical cell with a cathode, an anode and the described electrolyte composition, which is in contact with the cathode and the anode.

In an advantageous embodiment of the invention, the electrochemical cell is a lithium-ion cell, wherein the electrolyte composition includes the following components:

(A) sulfur dioxide; (B) 0.5-2 mol/L, preferably 0.4-1.5 mol/L, of a salt selected from the group composed of the compounds of Formulas (IV)-(XX) and Formulas (XXIV)-(XXVI) based on the total volume of the electrolyte composition; (C) 0.1-2 wt. % of lithium hexafluorophosphate and 0.1-2 wt. % of 4-fluoro-1,3-dioxolan-2-one (FEC), based respectively on the total weight of the electrolyte composition.

The lithium-ion cells described herein are inexpensive and can be safely operated at different working voltages. The associated electrochemical properties can be determined by measurements on test cells.

The cyclic aging resistance of the test cells can be determined via the number of cycles. The test cells are initially charged with a constant charging current up to a maximum permissible cell voltage. The upper cutoff voltage is kept constant until a charging current has fallen to a specified value or the maximum charging time has been reached. This is also known as I/U loading. The test cells are then discharged with a constant discharge current intensity up to a given cutoff voltage. Depending on the desired number of cycles, charging can be repeated. The upper cutoff voltage and the lower cutoff voltage, as well as the given charging or discharging current strengths, must be chosen experimentally. This also applies to the value to which the charging current has dropped.

The calendric aging resistance and the extent of self-discharge can be determined by storing a fully charged battery cell, in particular at elevated temperature.

To do this, the battery cell is charged up to the permissible upper voltage limit and maintained at this voltage until the charging current has dropped to a previously specified limit value. The cell is then disconnected from the power supply and stored in a temperature chamber at an elevated temperature, for example at 45° C., for a specific time, for example one month (Variant 1). The cell is then removed from the temperature chamber and the remaining capacity is determined under defined conditions. For this purpose, a discharge current is selected which, for example, numerically corresponds to one third of the nominal capacity, and the cell is thus discharged down to the lower discharge limit. This process can be repeated any number of times, for example until the detectable residual capacity has dropped to a predetermined value, for example 70% of the rated capacity.

In a second variant of the storage (Variant 2), the storage takes place in a temperature chamber with the power supply connected, the voltage corresponding to the upper voltage limit and this voltage being maintained. Tests are carried out according to the two storage variants. The actual calendric aging and the self-discharge of the battery cell is then determined from these tests: the calendric aging corresponds to the capacity loss due to storage according to Variant 2 and is calculated by subtracting the determined residual capacity 2 from the nominal capacity. The self-discharge rate is determined from the difference between the residual capacities 1 and 2 determined by storage according to Variants 1 and 2 in relation to the nominal capacity of the battery cell.

The cathode of the lithium-ion cell preferably includes a cathode active material.

Preferred cathode active materials for the electrochemical cell include lithium cobalt oxide (LCO), lithium nickel oxide (LNO), lithium nickel cobalt alumina (NCA), lithium nickel manganese cobalt oxide (NMC), lithium manganese oxide (LMO), lithium iron phosphate (LFP), lithium nickel manganese oxide (LMR), lithium nickel manganese oxide spinel (LNMO) and combinations thereof.

Lithium-nickel-manganese-cobalt compounds are also known under the abbreviation NMC, occasionally also under the technical abbreviation NCM. NMC-based cathode materials are used in particular in lithium-ion batteries for vehicles. NMC as a cathode material has an advantageous combination of desirable properties, for example a high specific capacity, a reduced cobalt content, high current capability and high intrinsic safety, which is reflected, for example, in sufficient stability in the event of overcharging.

NMC can be described with the general formula unit Li_{α}NiₓMn_{y}Co_{z}O₂, with x+y+z=1, where a denotes the specification of the stoichiometric proportion of lithium and is usually between 0.8 and 1.15. Certain stoichiometries are given in the literature as triples of numbers, for example NMC 811, NMC 622, NMC 532 and NMC 111. The triple number indicates the relative nickel:manganese:cobalt content. In other words, for example, NMC 811 is a cathode material, with the general formula unit LiNi_{0.8}Mn_{0.1}Co_{0.1}O₂, with α=1. Furthermore, the so-called lithium and manganese-rich NMCs having the general formula unit Li_{1+ε}(NiₓMnyCoz)_{1-ε}O₂ can also be used, where ε is in particular between 0.1 and 0.6, preferably between 0.2 and 0.4. These lithium-rich layered oxides are also known as overlithiated (layered) oxides (OLO).

In addition to the cathode active material, the cathode can have other components and additives, such as a foil carrier (rolled metal foil) or a metal-coated polymer foil, an electrode binder and/or an electrical conductivity improver, for example conductive carbon black. All customary compounds and materials known in the art can be used as further components and additives.

The anode of the lithium-ion cell preferably includes an anode active material.

In particular, the anode active material can be selected from the group composed of carbonaceous materials, soft carbon, hard carbon, natural graphite, synthetic graphite, silicon, silicon suboxide, silicon alloys, lithium, lithium alloys, aluminum alloys, indium, indium alloys, tin, tin alloys, cobalt alloys, niobium pentoxide, titanium dioxide, titanates, for example lithium titanates (Li₄Ti₅O₁₂ or Li₂Ti₃O₇), tin dioxide and mixtures thereof.

The anode active material is preferably selected from the group composed of synthetic graphite, natural graphite, graphene, mesocarbon, doped carbon, hard carbon, soft carbon, fullerene, silicon-carbon composite, silicon, surface-coated silicon, silicon suboxide, silicon alloys, lithium, aluminum alloys, indium alloys, tin alloys, cobalt alloys and mixtures thereof.

In addition to the anode active material, the anode can have other components and additives, such as a film carrier, an electrode binder and/or an electrical conductivity improver, for example conductive carbon black, conductive graphite, so-called “carbon nanotubes” (CNT), carbon fibers and/or graphene. All customary compounds and materials known in the art can be used as further components and additives.

### EXAMPLES

Some synthesis routes for salts of Formulas (IV)-(XX), (XXIV)-(XXVI) are given as examples. The other salts can also be synthesized with modifications that are customary in the art using the specified instructions.

### Example 1: Production of LiOTA (XXV)

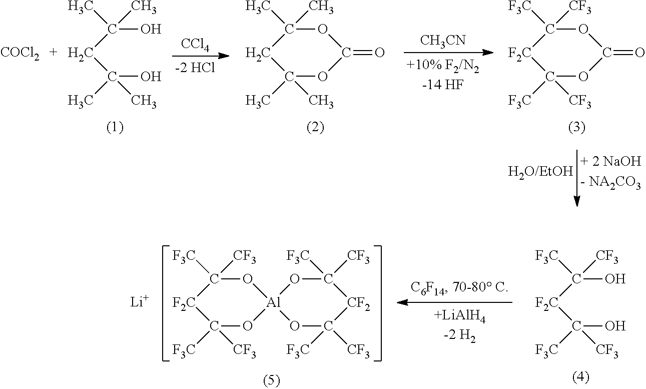

2,4-dimethylpentane-2,4-diol (1) is dissolved in carbon tetrachloride and reacted with phosgene (COCl₂) to give the corresponding 4,4,6,6-tetramethyl-1,3-dioxolane-2-dione (2). The obtained carbonate compound (2) is purified by fractional crystallization in diethyl ether and dried under a vacuum. In the next step, the dried carbonate compound (2) is dissolved in dry acetonitrile. A gas stream is passed through the resulting solution, the gas stream consisting of a fluorine:nitrogen mixture (10% by volume: 90% by volume). This converts the 4,4,6,6-tetramethyl-1,3-dioxolane-2-dione (2) to a perfluorinated carbonate compound (3) which can be isolated by drying under a vacuum. The perfluorinated carbonate is then treated with sodium hydroxide in aqueous alcoholic solution (H₂O/EtOH=1:1; % by volume/% by volume) to give 1,1,1,5,5,5-hexafluoro-2,3,3,4-tetrakis-trifluoromethylpentane-2,4-diol (4). The aqueous solution is then covered with a layer of diethyl ether and the diol (4) is transferred from the aqueous solution into the layered diethyl ether phase by acidification with hydrochloric acid. The diol (4) is purified by repeated crystallization with an aqueous alcoholic solution (H₂O/EtOH=1:1; vol. %/vol. %). In the final step, the diol (4) is converted with aluminum hydride (LiAlH₄) in perfluorohexane (C₆F₁₄) at 70-80° C. to lithium bis-[1,1,1,3,3,5,5,5-octafluoro-2,4-bis-trifluoromethylpentane-2,4-diolate)aluminate (LiOTA) (5).

### Example 2: Production of LiHTTDA (XXVI)

The salt lithium bis-(1,1,1,5,5,5-hexafluoro-2,3,3,4-tetrakis-trifluoromethylpentane-2,4-diolato)aluminate (LiHTTDA) can be represented according to the synthesis instructions of Example 1. 2,3,3,4-tetramethylpentane-2,4-diol is used as the starting material.

### Example 3: Preparation of lithium bis(perfluoropinacolato)borate (XXIV)

Lithium bis(perfluoropinacolato)borate can be synthesized according to the synthesis instructions of Wu Xu and C. Austen Angell (2000 Electrochem. Solid-State Lett. 3, 366).

Hexafluoro-2,3-bis(trifluoromethyl)-2,3-butanediol, lithium hydroxide dihydrate and boric acid are dissolved stoichiometrically in distilled water. The resulting solution is refluxed overnight. The solution is then cooled to room temperature and the remaining water is removed under a vacuum. The obtained reaction product lithium bis(perfluoropinacolato)borate is dried in a drying oven at 100° C. for 48 h. The reaction product is purified by vacuum sublimation at 130° C. with the formation of colorless crystals.

### Example 4

The ligands for the conductive salts (IV) and (VI) can be synthesized according to the synthesis instructions of J. D. O. Anderson et al. (1996 Inorg. Chem. 35, 3191).

The conductive salts (IV) and (VI) can be produced as follows:

All work is done under an argon flow: commercially available LiBH₄ (95%) is cleaned of the insoluble foreign matter by decantation with diethyl ether. The solvent is then removed in a vacuum and the purified material is dried at 80° C. The LiBH₄ cleaned in this manner is dissolved in a flask in 1,2-dimethoxyethane (DME) and refluxed as a clear solution. A 5% excess of the ligands of the conductive salts (IV) or (VI) is placed in DME in a dropping funnel and slowly added dropwise over a period of 1 h. Gas is produced during the addition of the ligands, and this quickly subsides as soon as the addition is stopped. After the addition is complete, the mixture is boiled under reflux for a further 15 minutes, giving a clear solution. The DME is then distilled off and the semi-dry residue is dried in a vacuum at 80° C. overnight. The yield is 90%. The purification takes place via extraction with perfluorohexane, which allows the insoluble components to be separated from the product.

### Example 5

The conductive salt (XVIII) can be synthesized according to the synthesis instructions of M. Eberwein et al. (2003 J. Electrochem. Soc. 150, A994).

### Example 6

The conductive salt (XIV) can be prepared as described below.

### a) Synthesis of the Ligand 2,2-ditrifluoromethylmaleic Acid

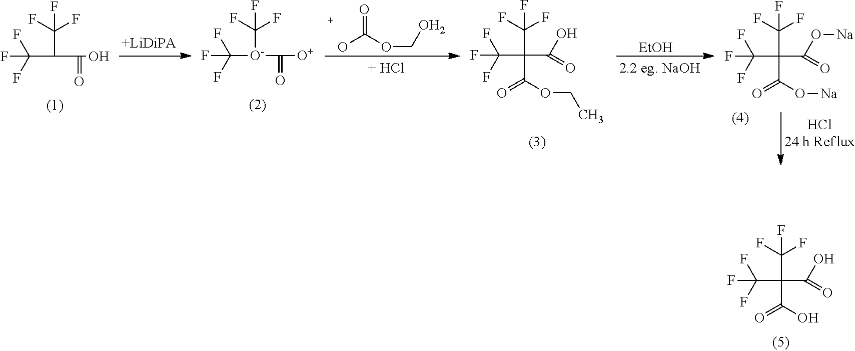

First, the required 2,2-ditrifluoromethylmalonic acid is synthesized from 2-(trifluoromethyl)-3,3,3-trifluoropropionic acid and lithium diisopropylamide according to the general synthesis instructions of AP Krapcho et al. (1974 Tetrahedron Letters 32, 2721), described below.

10 mL of n-butyllithium (2 M in hexane) is added to a solution of 20 mmol of diisopropylamine in 50 mL of THF (under N₂, −40° C.). The reaction mixture is stirred for 15 minutes. 10 mmol of 2-(trifluoromethyl)-3,3,3-trifluoropropionic acid (1) is then added, and the mixture is heated to 50° C. and kept at this temperature for 1 hour to obtain a tertiary carbanion intermediate (2). The mixture is then cooled to −70° C., and 10 mmol of ethyl chloroformate is added. The reaction mixture is slowly brought to room temperature while stirring and then poured onto 100 g of ice. Then 30 mmol of HCl is added to obtain a 2,2-ditrifluoromethylmalonic acid monoethyl ester (3) and extracted with several 25 ml portions of diethyl ether. The ethereal phases are collected and concentrated. The oily monoethyl 2,2-ditrifluoromethylmalonate is then distilled in a vacuum.

The ester (3) is then converted into 2,2-ditrifluoromethylmalonic acid (5) via the intermediate (4) analogously to the instructions in the Electronic Supplementary Information of Wan et al. in Chem. Commun., 2015, 51, 9817.

### b) Synthesis of lithium bis[2,2-bis(trifluoromethyl)malonato]borate

The boron salt is synthesized analogously to the procedure published by Liao et al. (2014 Adv. Energy Mater. 4, 1301368).

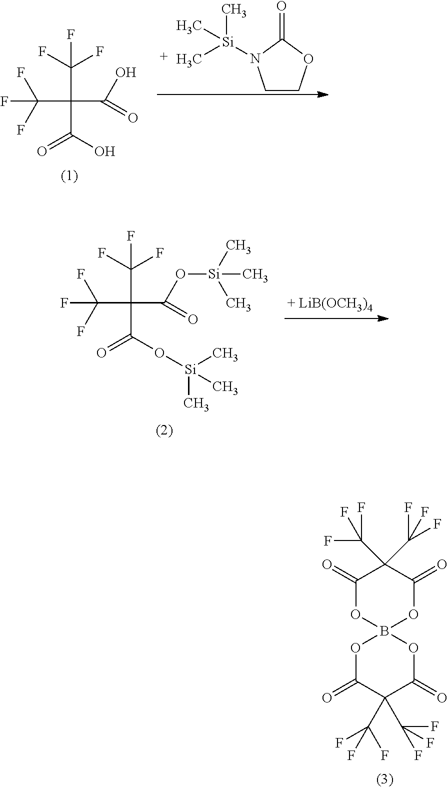

Ditrifluoromethylmalonic acid (1) is reacted with 3-trimethylsilyl-2-oxazolidinone to give di(trifluoromethyl)di(trimethylsilyl)malonate (2). Lithium bis [2,2-bis(trifluoromethyl)malonato] borate (3) can be isolated by subsequent addition of lithium tetramethylborate.

### Example 7

The conductive salt (X) can be prepared as follows:

### a) Synthesis of 2-fluoro-2-trifluoromethylmalonic acid

2,3,3,3-tetrafluoropropionic acid is used as the starting basis for the synthesis. The synthesis instructions are analogous to the synthesis described above for the conductive salt No. XIV.

### b) Synthesis of lithium bis(2-fluoro-2-trifluoromethylmalonato)borate

The synthesis is analogous to the procedure published by Liao et al. in 2014 Adv. Energy Mater. 4 1301368.

### Example 8

The conductive salt (XIX) can be synthesized according to the synthesis instructions of J. Barthel et al. (1996 J. Electrochem Soc. 143, 3572).

1-20. (canceled)

21. A liquid electrolyte composition for an electrochemical cell, comprising the following components:
(A) sulfur dioxide; and
(B) at least one salt, wherein the salt comprises an anionic complex having at least one bidentate ligand and the salt corresponds to Formula (I), 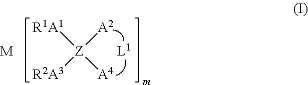
Formula (II), 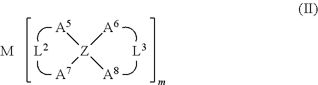
or Formula (III), 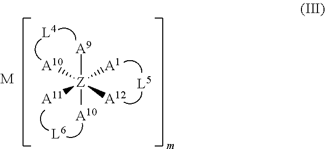
and combinations thereof,
wherein
M is a metal cation selected from the group consisting of the alkali metals, alkaline earth metals, and metals of group 12 of the periodic table;
m is 1 or 2;
Z is a central ion selected from the group consisting of elements of group 2 to 16 of the periodic table, and lanthanides;
A₁ to A₁₂ each represent a coordination element that bonds to the central ion Z,
wherein A₁ to A₁₂ are each independently selected from the group consisting of elements of group 15 and 16 of the periodic table;
R₁ and R₂ each represent a monovalent and terminal radical and are independently selected from the group consisting of a fluorine-substituted hydrocarbon radical, triflyl radical, triflate radical, and fluorosulfonate radical; and
L¹ to L⁶ each independently represent an aliphatic or aromatic bridging group, wherein the bridging group forms a five to eight-membered ring with the central ion Z and with two coordination elements bonded to the central ion Z and the bridging group, and wherein the ring comprises a sequence of 2 to 5 carbon atoms.

22. The liquid electrolyte composition according to claim 21, wherein the metal cation M is lithium and the component (B) is a lithium salt.

23. The liquid electrolyte composition according to claim 21, wherein the central ion is selected from the group consisting of B, Al, Ga, In, P, Ti, Nb, Zn, V and La.

24. The liquid electrolyte composition according to claim 21, wherein at least one coordination element comprises oxygen.

25. The liquid electrolyte composition according to claim 21,
wherein the salt corresponds to Formula (I), wherein R₁ and R₂ each independently comprise a hydrocarbon radical selected from the group consisting of C₁-C₈ alkyl, C₂-C₁₀ alkenyl, C₂-C₁₀ alkinyl, C₆-C₁₂ cycloalkyl and C₆-C₁₂ aryl, and
wherein the hydrocarbon radical is at least partly fluorine-substituted.

26. The liquid electrolyte composition according to claim 21, wherein the ring comprises a continuous sequence of 2 to 5 carbon atoms.

27. The liquid electrolyte composition according to claim 21, wherein the ring comprises a sequence of 2 to 5 carbon atoms interrupted by a heteroatom.

28. The liquid electrolyte composition according to claim 21, wherein the ring comprises at least one carbonyl group selected from the group consisting of an imide group, carboxylic acid ester group, carboxylate group, ketone group, carboxylic anhydride group, carbonic acid ester group, and carbamate ester group.

29. The liquid electrolyte composition according to claim 21,
wherein L¹ to L⁶ each independently comprise a linear, branched or cyclic, saturated, fluorine-substituted hydrocarbon skeleton, and
wherein the hydrocarbon skeleton comprises 3 to 16 carbon atoms, and the hydrocarbon skeleton being at least partly fluorine-substituted.

30. The liquid electrolyte composition according to claim 21,
wherein the component (B) of the liquid electrolyte composition comprises at least one lithium salt of Formula (II), and
wherein the lithium salt is selected from the group consisting of 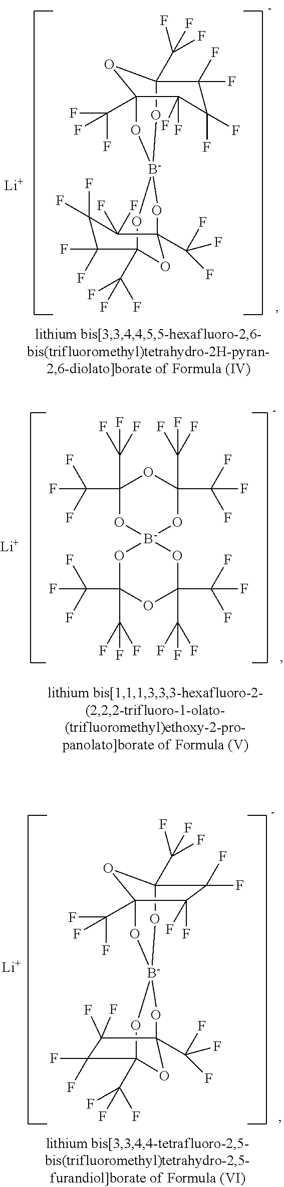
and combinations thereof.

31. The liquid electrolyte composition according to claim 21,
wherein the component (B) of the liquid electrolyte composition comprises at least one lithium salt of Formula (II), and
wherein the lithium salt is selected from the group consisting of 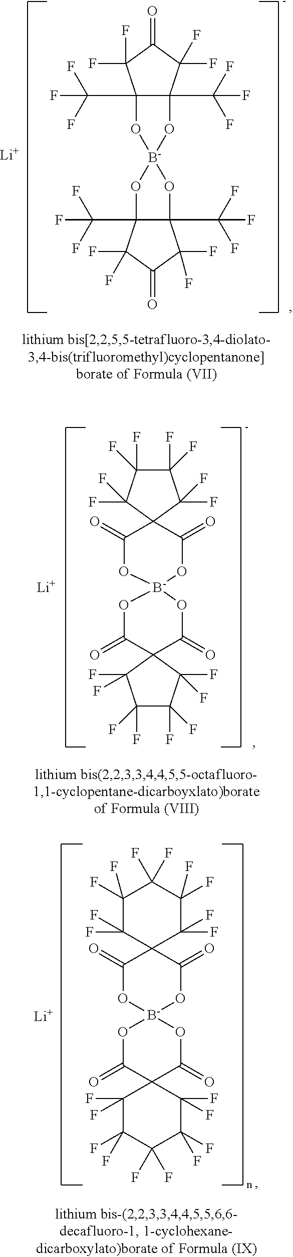 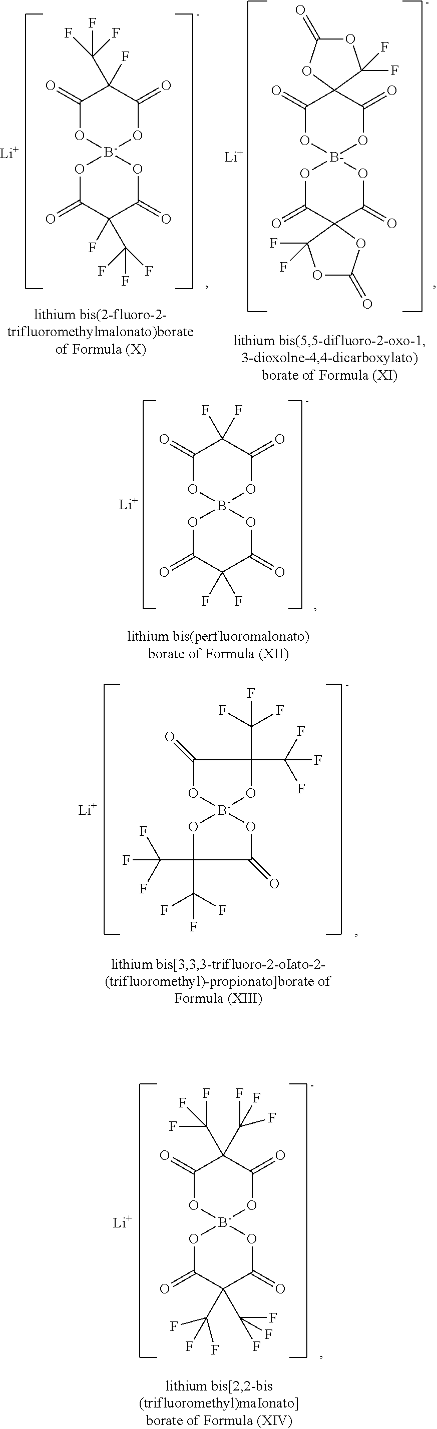 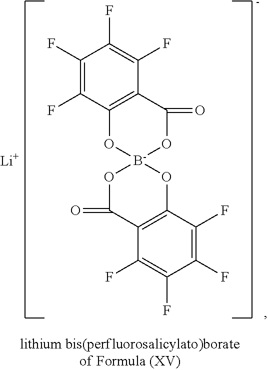
and combinations thereof.

32. The liquid electrolyte composition according to claim 21,
wherein the component (B) of the liquid electrolyte composition comprises at least one lithium salt of Formula (II), and
wherein the lithium salt is selected from the group consisting of 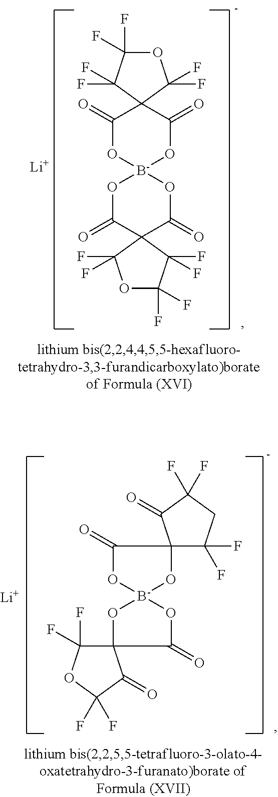
and combinations thereof.

33. The liquid electrolyte composition according to claim 21,
wherein the component (B) of the liquid electrolyte composition comprises at least one lithium salt of Formulas (II) or (III), and
wherein the lithium salt comprises a fluorine-substituted aromatic bridging group and the lithium salt is selected from the group consisting of 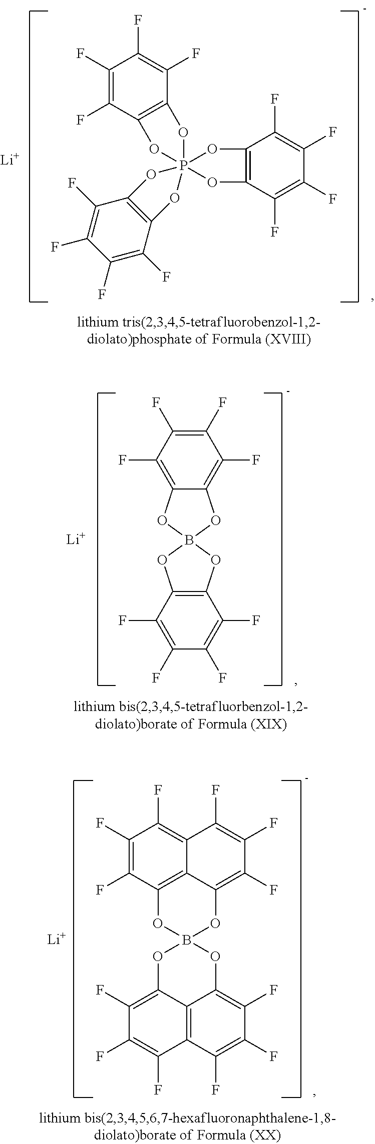
and combinations thereof.

34. The liquid electrolyte composition according to claim 21, wherein the salt of the component (B) is a salt of Formula (XXI) 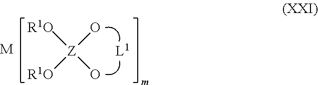
or Formula (XXII) 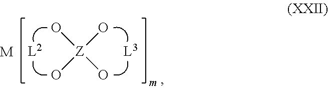
wherein Z is a central ion selected from the group consisting of aluminum and boron.

35. The liquid electrolyte composition according to claim 34,
wherein the component (B) of the liquid electrolyte composition comprises at least one lithium salt of Formula (XXII), and
wherein the lithium salt is selected from the group consisting of B(O₂C₂(CF₃)₄)₂ (LiBPFPB) of Formula (XXIV), 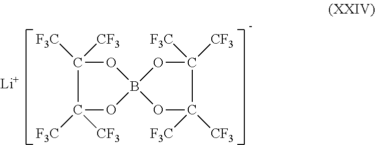
Al(O₂C₂(CF₃)₄CF₂)₂ (LiOTA) of Formula (XXV), 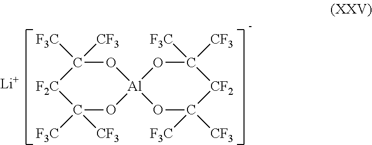
Al(O₂C₃(CF₃)₆)₂ (LiHTTDA) of Formula (XXVI), 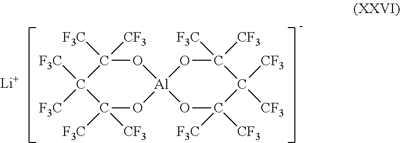
and combinations thereof.

36. The liquid electrolyte composition according to claim 21, wherein the liquid electrolyte composition comprises the component (B) in a concentration of 0.01 to 15 mol/L, based on the total volume of the liquid electrolyte composition.

37. The liquid electrolyte composition according to claim 21,
wherein the liquid electrolyte composition comprises at least one further additive in an amount of 0-10 wt. %, based on the total weight of the liquid electrolyte composition, and
wherein the further additive is selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI), bis-(fluorosulfonyl)imide (LiFSI), and combinations thereof.

38. The liquid electrolyte composition according to claim 21,
wherein the component (B) of the liquid electrolyte composition has at least one salt of Formula (I), Formula (II) or Formula (III) in a concentration of 0.01-15 mol/L, based on the total volume of the liquid electrolyte composition, wherein the salt is a lithium salt selected from the group consisting of the compounds of Formulas (IV-XX), Formulas (XXIV-XXVI), and combinations thereof; and the liquid electrolyte composition further comprises:
(C) 0-10 wt. % of at least one additive, wherein the additive is selected from the group consisting of vinylene carbonate (VC), 4-fluoro-1,3-dioxolan-2-one (FEC), lithium hexafluorophosphate, cis-4,5-difluoro-1,3-dioxolan-2-one (cDFEC), 4-(trifluoromethyl)-1,3-dioxolan-2-one, bis-(trifluoromethanesulfonyl)imide (LiTFSI), bis-(fluorosulfonyl)imide (LiFSI), and combinations thereof, based on the total weight of the liquid electrolyte composition.

39. An electrochemical cell having a cathode, an anode, and a liquid electrolyte composition, which is in contact with the cathode and the anode,
wherein the liquid electrolyte composition comprises the following components:
(A) sulfur dioxide; and
(B) at least one salt, wherein the salt comprises an anionic complex having at least one bidentate ligand and the salt corresponds to Formula (I), 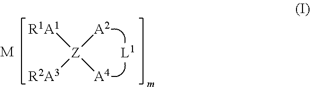
Formula (II), 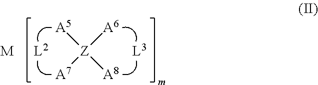
or Formula (III), 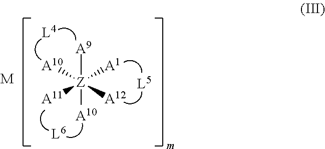
and combinations thereof;
wherein
M is a metal cation selected from the group consisting of the alkali metals, alkaline earth metals, and metals of group 12 of the periodic table;
m is 1 or 2;
Z is a central ion selected from the group consisting of elements of group 2 to 16 of the periodic table, and lanthanides;
A₁ to A₁₂ each represent a coordination element that bonds to the central ion Z, wherein A₁ to A₁₂ are each independently selected from the group consisting of elements of group 15 and 16 of the periodic table;
R₁ and R₂ each represent a monovalent and terminal radical and are independently selected from the group consisting of a fluorine-substituted hydrocarbon radical, triflyl radical, triflate radical, and fluorosulfonate radical; and
L¹ to L⁶ each independently represent an aliphatic or aromatic bridging group, wherein the bridging group forms a five to eight-membered ring with the central ion Z and with two coordination elements bonded to the central ion Z and the bridging group, and wherein the ring comprises a sequence of 2 to 5 carbon atoms.

40. The electrochemical cell according to claim 39,
wherein the electrochemical cell is a lithium-ion cell,
wherein the component (B) of the liquid electrolyte composition has a salt of Formula (XXV) in a concentration of 0.5-2 mol/L, based on the total volume of the liquid electrolyte composition; and the liquid electrolyte composition further comprises:
(C) 0.1-2 wt. % of lithium hexafluorophosphate and 0.1-2 wt. % of 4-fluoro-1,3-dioxolan-2-one (FEC), each based on the total weight of the liquid electrolyte composition.
